(19) United States
(12) Patent Application Publication
(10) Pub. No.: US 2024/0236434 A1
(43) Pub. Date: Jul. 11, 2024

(54) CONNECTED TELEVISION LIVESTREAM-TO-MOBILE DEVICE HANDOFF IN AN ECOMMERCE ENVIRONMENT

(71) Applicant: Loop Now Technologies, Inc, San Mateo, CA (US)

(72) Inventors: Michael A. Shoss, Milton (CA); Daniel Scott Rapaport, Redwood City, CA (US)

(73) Assignee: Loop Now Technologies, Inc., San Mateo, CA (US)

(21) Appl. No.: 18/405,012

(22) Filed: Jan. 5, 2024

Related U.S. Application Data
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/613,312, filed on Dec. 21, 2023.

(51) Int. Cl. H04N 21/478; G06F 16/955; H04N 21/2187

(52) U.S. Cl. CPC H04N 21/47815; G06F 16/9554; H04N 21/2187

(57) ABSTRACT

Disclosed embodiments provide techniques for connected television livestream-to-mobile device handoff in an ecommerce environment. A livestream or livestream replay is accessed on a device for connected television (CTV) that facilitates delivery of streaming video content to a user. A quick response (QR) code is revealed on the CTV device. A user scans the QR code with a camera located on a mobile device, and the QR code redirects the mobile device to a website. The website enables participation in a livestream using the mobile device. Products for sale can be highlighted by a livestream host during the livestream. The products for sale can be identified and an ecommerce purchase of the products for sale can be enabled. Promotions related to the products for sale can be displayed to the user on the CTV and mobile device during the ecommerce purchase process.

### RELATED APPLICATIONS

This application claims the benefit of U.S. provisional patent applications “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video processing and more particularly to connected television livestream-to-mobile device handoff in an ecommerce environment.

### BACKGROUND

One of the great challenges of successfully marketing a product is getting access to potential customers so that they can decide whether or not to buy. The buying and selling of goods dates back more than 10,000 years. Archaeologists have uncovered coinage as old as the 7^{th} century BC. Open air, public markets are known to have been a central part of life in ancient Babylonia, Assyria, Phoenicia, Greece, Rome, and Egypt. As civilizations grew, direct access to tradesmen by customers became common, allowing buyers to discuss options for both products and purchasing methods. Eventually, permanent shops began to emerge, especially in towns and cities, attracting shoppers from local and more remote locations. By the 13^{th} century, specific sections of cities became specialized shopping centers. Advertising at this time consisted largely of signs or placards at the entrance to the shop and the loud voice of the owner crying out news of their wares on the street. Market towns sprang up across Europe and the Americas. The Grand Bazaar of Istanbul is referred to as the world's oldest continually operating market, starting in 1455 AD. As production practices improved, goods began to be sold and transported over greater distances. Guilds of tradesmen and skilled workers in specific industries banded together, and resellers of goods began to compete with them, growing the marketplace and benefiting consumers. In the late 17^{th} century, retail stores began to install counters, display cases, mirrors, changing rooms, and so on, allowing customers to touch and feel products. Soon shopping arcades with shops run by multiple vendors under a single covered roof began to emerge. These arcades became places for not only buying and selling, but also socializing. They were places to see and to be seen in.

The Industrial Revolution only served to accelerate buying and selling across broader and broader areas. Department stores emerged in the mid- to late 19^{th} century, providing venues where shoppers could spend leisure time and be entertained, as well as purchase goods and services. Mail order retail grew as catalog sales flourished in the 1870s, 80s, and 90s. Money-back guarantees became commonplace as the ability to purchase goods from across the country or across the globe grew. A natural expansion of the catalog idea came in the 1990s as internet online shopping appeared. Online bookstores have given way to vast retail outlets with products and services from thousands of vendors. Online auction sites allow users to resell old items as well as new ones; sites for artisans allow single owners to sell their wares worldwide. Along with the explosion of online marketing outlets, the demand from consumers to “touch and feel” the merchandise has not subsided. Livestream events, hosted by vendors, advertisers, or social networks, have become more important recently, giving consumers the opportunity to interact directly with artisans, vendors, celebrity hosts, and one another in real time. Viewers can virtually touch and feel the merchandise as they interact with others who have already purchased the products. As in the past, they can see and be seen as they share their observations, comment on trends, or spend leisure time chatting with one another. The livestream events of today have become the online counterpart to the department stores of the 1800s and all of the variations of public buying and selling that have gone before.

### SUMMARY

Techniques for connected television livestream-to-mobile device handoff in an ecommerce environment are disclosed. Livestreaming has become an increasingly popular means of accessing television programs and movies, viewing sporting events, accessing news, and purchasing products and services. Personal electronic devices including mobile devices are used to access many types of information on the Internet. The electronic devices, which can include desktop computers; laptop computers; and personal electronic devices such as tablets, smartphones, and PDAs are widely used by individuals to observe and interact with online media content. Some of the most popular livestream content provided includes product information. The livestream event includes video streams, audio, text, images, etc., and provides a forum for the individual or team to present thoughts, comments, and reactions to a wide variety of goods and services. The livestream events can be generated using a vast assortment of electronic devices such as smartphones, tablet computing devices, televisions, laptop computers, desktop computers, and digital video cameras, among many others. The opportunity for viewers to participate directly in livestream events as they occur is attracting increasing numbers of consumers. In light of these trends, the generation of livestream videos is taking on a significantly more important role in information dissemination, education, advertisement, and entertainment.

Disclosed embodiments provide techniques for connected television livestream-to-mobile device handoff in an ecommerce environment. A livestream or livestream replay is accessed on a device for connected television (CTV) that facilitates delivery of streaming video content to a user. A quick response (QR) code is revealed on the CTV device. A user scans the QR code with a camera located on a mobile device, and the QR code redirects the mobile device to a website. The website enables participation in a livestream using the mobile device. Products for sale can be highlighted by a livestream host during the livestream. The products for sale can be identified and an ecommerce purchase of the products for sale can be enabled. Promotions related to the products for sale can be displayed to the user on the CTV and mobile device during the ecommerce purchase process.

A computer-implemented method for video processing is disclosed comprising: accessing a livestream on a device for connected television (CTV), wherein the CTV facilitates delivery of streaming video content to a user; revealing a quick response (QR) code, using one or more processors, on the device for CTV; scanning the QR code, by the user, with a camera located on a mobile device, wherein the QR code redirects the mobile device to a website; enabling participation in the livestream by the user, via the website, wherein the enabling is accomplished with the mobile device; and enabling an ecommerce purchase of a product for sale using the mobile device. Some embodiments comprise identifying when a livestream host highlights the product for sale in the livestream. In embodiments, the enabling an ecommerce purchase further comprises pinning a product card, using one or more processors, by the livestream host, within a shopping window on the device for CTV. In embodiments, the product card represents the product for sale. Some embodiments comprise revealing a second QR code within the shopping window. And some embodiments comprise scanning the second QR code, by the user, with the camera located on the mobile device.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for CTV livestream-to-mobile device handoff in an ecommerce environment.

FIG. 2 is a flow diagram for enabling an ecommerce purchase.

FIG. 3 is an infographic showing CTV livestream-to-mobile device handoff in an ecommerce environment.

FIG. 4 is an infographic for pinning a product card based on speech analysis.

FIG. 5 is an infographic for pinning a product card based on gaze detection.

FIG. 6 is an infographic for an ecommerce purchase environment on a mobile device.

FIG. 7 is an infographic for a promotion in the livestream.

FIG. 8 is an infographic for a poll in a livestream ecommerce environment.

FIG. 9 is an infographic for a virtual purchase cart in a livestream ecommerce environment.

FIG. 10 is a system diagram for connected television livestream-to-mobile device handoff in an ecommerce environment.

### DETAILED DESCRIPTION

Livestream events are becoming a vital channel for retail marketing. They provide opportunities for hosts, influencers, vendors, advertisers, and customers to interact with one another and products and services for sale in a direct, real time virtual environment. Chats, polls, and questions can be generated and sent directly to participants. Hosts or vendors can conduct demonstrations of products. Users can ask questions and get immediate feedback from other viewers, hosts, vendors, or influencers. Accessing livestream events quickly and easily has thus become more important in engaging and retaining potential customers. Connected television (CTV) devices have become an increasingly common method of viewing livestream events. CTV devices can be any television set connected to the Internet. As well as smart TVs with built-in internet connectivity, CTVs can include televisions connected to the Internet via set-top boxes, TV sticks, and gaming consoles. Connected TV can also include Over-the-Top (OTT) video devices or services accessed by a laptop, desktop, pad, or mobile phone. Content for television can be accessed directly from the Internet without using a cable or satellite set-top box. In some embodiments, CTV can include a connected public display or a connected commercial display. Wi-Fi hotspots built into public parks, transportation portals, government buildings, and so on, can allow visitors and employees to connect to both public and secure content via mobile phones, pads, or laptop computers. Visitor centers can allow users to purchase tickets to events in advance and receive guided tours of zoos and other attractions via mobile phones, etc. Any of these devices or services can be used to access livestream events as they occur or as they are replayed by a host system at a later time.

Quick Response (QR) codes are machine-readable matrix barcodes made up of an array of black and white squares. They are typically used to store URLs or other information to be read by a camera on a smartphone. A single QR code can contain up to three hundred alphanumeric characters. QR codes can be easily generated using standardized software available for little or no cost. As livestream events are displayed on CTV devices, QR codes can be generated and revealed on the CTV devices within the livestream window. The QR code can be scanned by a mobile device using a camera included in the device. Optical scanning software included on a mobile phone can read the QR code and translate the code into a URL address that allows the user to participate in the livestream event on the mobile phone. The accessing the livestream on the mobile device can be accomplished using a browser or another application running on the mobile device. Access to the livestream can be delivered to the viewer as the event occurs, allowing the viewer to participate directly and immediately. Both the CTV and mobile device can be viewed simultaneously. Additional QR codes can be generated and revealed on the CTV device granting viewers access to chats, polls, questionnaires, and ecommerce environments on the mobile device without losing access to the main livestream window. Chats, host interactions, and the opportunity to purchase goods and services presented as part of the livestream event can be responded to in real time, making the likelihood of successful sales significantly greater.

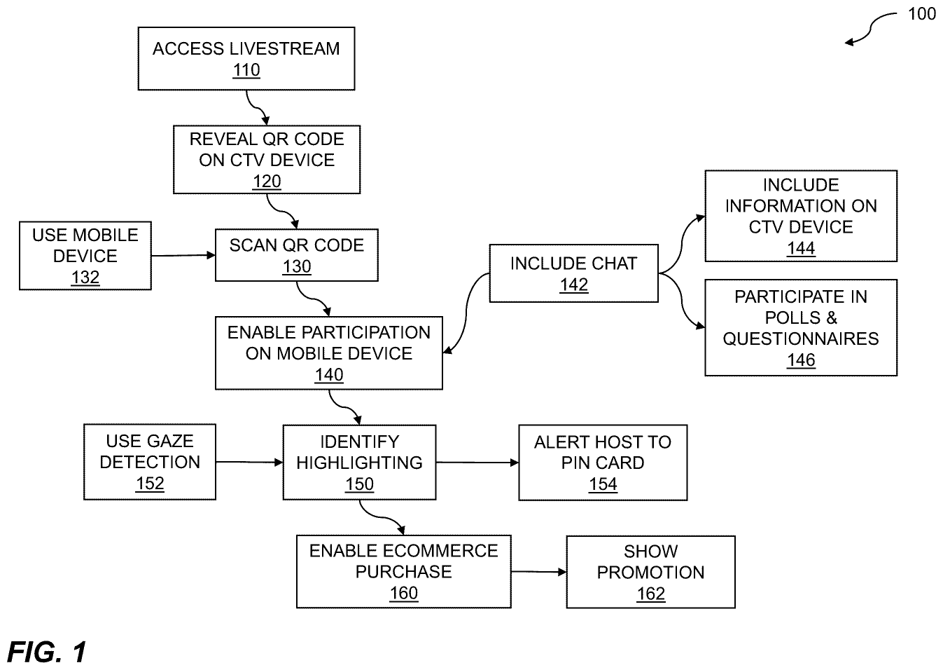

FIG. 1 is a flow diagram for CTV livestream-to-mobile device handoff in an ecommerce environment. The flow 100 includes accessing a livestream event 110 on a device for connected television (CTV), wherein the CTV facilitates delivery of streaming video content to a user. A livestream event is a real-time interactive audio-visual session that can be initiated by using a video source and an audio source that are accessible to a computing device. The video source can include a video camera, a webcam, a handheld device such as a tablet or smartphone, and so on. The audio source can include a separate audio pickup device such as a USB microphone, a microphone built into a computer or handheld device, etc. The video and the audio can be encoded using an encoder that is suitable for livestreaming. The encoding can be accomplished using a hardware encoder, a software encoder, a combination of hardware and software, etc. The livestream can be initiated through a livestream platform. The livestream platform can include a commercial platform, a social media platform, and the like. Viewers can access the livestream event 110 by pointing a web browser to a uniform resource locator address (URL) by opening an app loaded on an electronic device that supports livestream events, including CTV, etc. Connected television (CTV) is any television set connected to the Internet. Connected television sets are most commonly used to stream videos. As well as smart TVs with built-in internet connectivity, CTVs can include televisions connected to the Internet via set-top boxes, TV sticks, and gaming consoles. Connected TV can also include Over-the-Top (OTT) video devices or services accessed by a laptop, desktop, pad, or mobile phone. Content for television can be accessed directly from the Internet without using a cable or satellite set-top box. For example, watching a movie or television episode using a laptop or mobile phone browser is considered OTT. In some embodiments, CTV can include a connected public or commercial display. Wi-Fi hotspots built into public parks, transportation portals, government buildings, and so on can allow visitors and employees to connect to both public and secure content via mobile phones, pads, or laptop computers. Visitor centers can allow users to purchase tickets to events in advance to receive guided tours of zoos and other attractions via mobile phones, etc. Any of these devices or services can be used to access livestream events as they occur or as they are replayed by a host system at a later time.

The flow 100 includes revealing a QR code on the CTV device 120 during the livestream event 110. A QR code is a machine-readable matrix barcode made up of an array of black and white squares. QR codes are typically used to store URLs or other information to be read by a camera on a smartphone. A single QR code can contain up to three hundred alphanumeric characters. The codes can be easily generated using standardized software available for little or no cost. In embodiments, a QR code containing the web address of a livestream URL can be generated and revealed on the screen of a CTV device 120 as the livestream progresses. The flow 100 includes a user scanning a QR code 130 using a mobile device 132. An optical scanning program included on a mobile phone can read the QR code displayed on a CTV screen 120 and can translate the code into a URL address that enables the user to participate in the livestream event on the mobile device 140. In embodiments, the accessing the livestream on the mobile device can be accomplished using a browser or another application running on the mobile device. In some embodiments, the livestream comprises a short-form video.

The flow 100 includes a chat function 142 as part of the livestream event that is enabled for the user from a mobile device. In embodiments, the chat function is displayed on a CTV device 144 and the mobile phone as the livestream event progresses. The chat function can appear on connected public or commercial displays that show the livestream event. The user can participate in the livestream chat 142 using the mobile device that displays the livestream event. In some embodiments, the livestream chat can include polls and questionnaires 146 in which the user can participate. As the user participates in polls and questionnaires 146 and chats 142, the chat contents appear on both the mobile device and the CTV device 144 which is displaying the livestream event.

The flow 100 includes identifying highlighting 150 of at least one product for sale in the livestream event. The products can include a wide variety of items such as household items, automotive parts and accessories, cosmetic items, haircare products, clothing items, electronic devices, and myriad other products. In embodiments, at least one product for sale can be a service or event. Depending on the type of product, the livestream host can handle the product, demonstrate the product, etc. In embodiments, the livestream window can be rendered on a screen associated with a computing device, a handheld device, a television, a CTV, an OTT device, a projector, and so on. The livestream window can include a window associated with a web browser, a window associated with a video playing or video stream application or app, and the like. In other embodiments, the livestream event can be rendered in a playlist. The playlist can include a playlist of previously recorded livestreams, livestreams currently available, a schedule of future livestreams, etc.

A livestream event can include pinning a product card in the livestream window by the host. The product card that is pinned represents the at least one product for sale. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. When the product card is invoked, an additional on-screen display is rendered over a portion of the video while the video continues to play. The flow 100 includes alerting the livestream host to pin a product card 154 associated with the at least one product for sale. The alerting can occur when the host is identified to be highlighting the at least one product for sale. The identifying that the host is highlighting a product can be accomplished using a variety of techniques. The identifying can be based on machine learning, where the machine learning can determine that a product for sale is being handled by the host. The identifying can also be based on speech analysis. The speech analysis, which can be accomplished using natural language processing, can be used to determine when the host is talking about the product. The host may or may not be handling the product while they are talking about the product. The identifying can further be based on gaze detection 152 for the gaze of the livestream host. The host can be looking at or in the direction of the product for sale. The gaze detection can be used to alert the host to pin the product card 154 so that the livestream event users can learn more about the product and purchase the product. The identification of products within a video can be based on pattern recognition, optical identifiers, etc. The optical identifiers can include information on product labels. The information can include barcodes, text, images, and/or other optical patterns imprinted or rendered on the product. In embodiments, the identification of products is performed automatically, and a product tag, which can include a highlight indication, is generated and rendered on the video. The highlight indication can track the motion of the associated product or object as it is moved within the video. In some embodiments, multiple highlight indications can be simultaneously rendered in a video. This can occur, for example, when multiple products are being featured, compared, or otherwise discussed concurrently.

The flow 100 includes enabling an ecommerce purchase 160 of the at least one product for sale by the viewer, wherein the ecommerce purchase is accomplished within the livestream window. The enabling can include rendering a product card associated with the product. The enabling can include revealing a virtual purchase cart that supports checkout, including specifying various payment methods, and applying coupons and/or promotional codes 162. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items are purchased via product cards during the playback of a short-form video, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

When the product card is invoked, an additional on-screen display is rendered over a portion of the video while the video continues to play. This rendering enables an ecommerce purchase 160 by a user while preserving a continuous video playback session. In other words, the user is not redirected to another site or portal that causes the video playback to stop. Thus, users are able to initiate and complete a purchase completely inside of the video playback user interface, without being directed away from the currently playing video. Allowing the video to play during the purchase can enable improved audience engagement which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

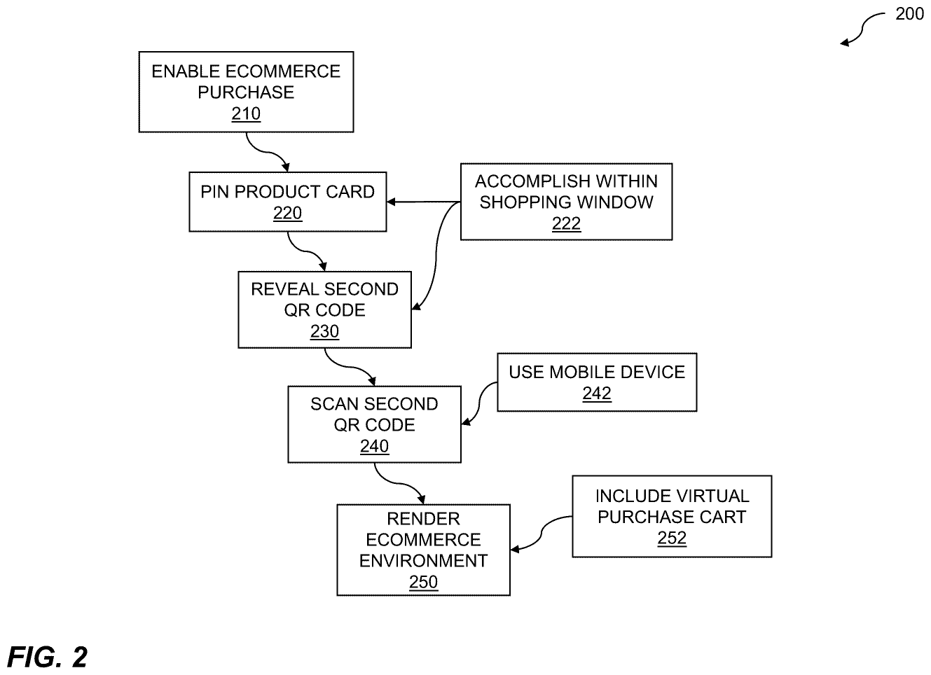

FIG. 2 is a flow diagram for enabling an ecommerce purchase. A livestream event is hosted and viewed by one or more viewers. The viewers can view the livestream event using CTV devices, mobile devices, etc. Mobile device viewers can both view and engage with the livestream host as the host discusses products for sale using a chat function. The host can demonstrate, endorse, recommend, and otherwise interact with the product for sale. An ecommerce purchase of the at least one product for sale is enabled to the viewer, wherein the ecommerce purchase is accomplished within the livestream window. As the host interacts with and presents the products for sale, a product card is pinned within a livestream shopping window. A second QR code can be generated and revealed in the livestream shopping window. The viewer can scan the second QR code using a mobile device. The mobile device can be the same as the one used to view the livestream event. The second QR code can be used to render an ecommerce environment associated with the livestream event. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale are revealed, wherein the revealing is rendered to the viewer. The viewer can purchase the product through the ecommerce environment, including a virtual purchase cart.

The flow 200 includes enabling an ecommerce purchase 210 of at least one product for sale during a livestream event. The ecommerce purchase can be accomplished within the livestream window. Viewers of the livestream event can purchase a product, a service, etc. being promoted by the host of the livestream event. A viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event.

The flow 200 includes pinning a product card 220 that represents the one or more products for sale during a livestream event. In embodiments, the pinning of a product card 220 can be accomplished, using one or more processors, by the livestream host within a shopping window 222 on the CTV device. The pinning the product card 220 can include inserting a representation of a product or service for sale into the on-screen product card. A product card is a graphical element such as an icon, thumbnail picture, thumbnail video, symbol, or other suitable element that is displayed in front of the video. When the product card is invoked, an additional on-screen shopping window 222 is rendered over a portion of the livestream video while the video continues to play. This rendering enables a CTV viewer to view purchase information about a product/service while preserving a continuous video playback session.

The flow 200 includes generating and revealing a second QR code 230 in the livestream event product card on the CTV device. In embodiments, the second QR code 230 contains information to render an ecommerce environment related to the livestream event on the mobile device 242 scanning the second QR code 240. The viewer of a livestream event can scan the second QR code 240 using the same mobile device 242 that was used with the first QR code. In embodiments, the ecommerce environment is rendered on the mobile device so that livestream event is still visible. The product card in the ecommerce environment is selectable via a user interface action such as a press, swipe, gesture, mouse click, verbal utterance, or other suitable user action. In other words, the user is not redirected to another site or portal that causes the video playback to stop. Thus, users are able to initiate and complete a purchase completely inside of the video playback user interface, without being directed away from the currently playing video. Allowing the video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. In the flow 200, the pinning is accomplished using one or more processors. The processors can be associated with a computing device such as a desktop or laptop computer. The processors can be associated with a server on which the livestream event is hosted.

In the flow 200, the rendering of the ecommerce environment 250 includes a virtual purchase cart 252, wherein the virtual purchase cart is rendered to the viewer. The virtual purchase cart can appear as an icon, a pictogram, a representation of a purchase cart, and so on. The virtual purchase cart can appear as a cart, a basket, a bag, a tote, a sack, and the like. In the flow 200, the livestream event displays the virtual purchase cart to the viewer during the livestream based on scanning the second QR code revealed 230 on the CTV device. Using a mobile device, the viewer can click on the product or on the virtual purchase cart to add the product to the purchase cart. The viewer can click again on the virtual purchase cart to open the cart and display cart contents. The viewer can save the cart, edit the contents of the cart, delete items in the cart, etc. In the flow 200, the virtual purchase cart 252 rendered to the viewer covers a portion of the livestream window. The portion of the livestream window can range from a small portion to substantially all of the livestream window. However much of the livestream window is covered by the virtual purchase cart, the livestream event continues to play while the viewer is interacting with the virtual purchase cart.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

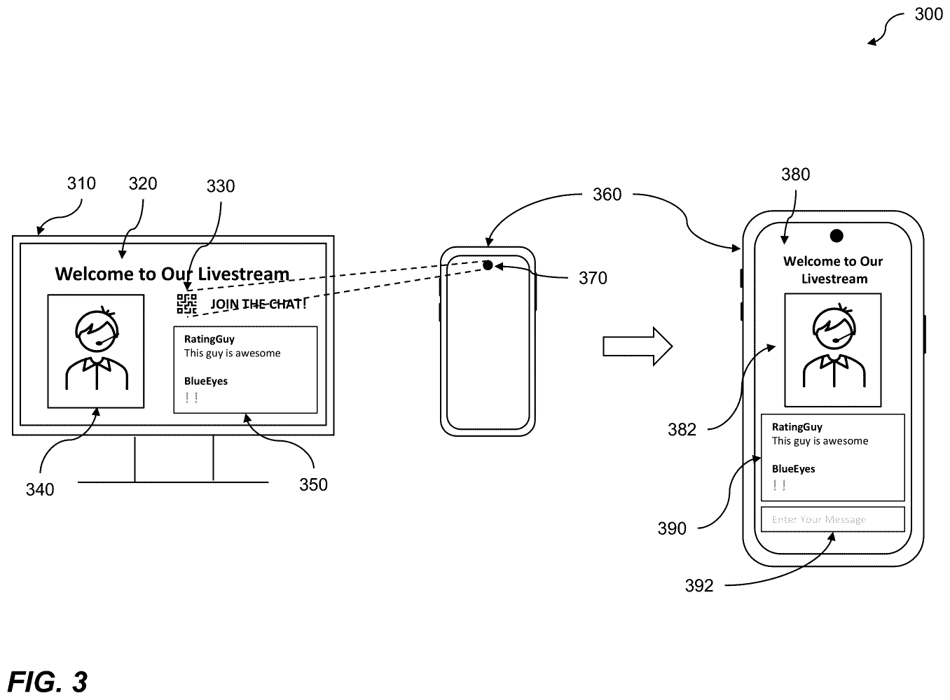

FIG. 3 is an infographic showing CTV livestream-to-mobile device handoff in an ecommerce environment. A livestream event is displayed on a CTV device. The CTV device can be a smart TV which can be directly attached to the Internet; a television connected to the Internet via a cable box, TV stick, or game console; an Over-the-Top (OTT) device such as a mobile phone, laptop computer, tablet, pad, or desktop computer, etc. The device for CTV can be a connected public or commercial display. In some embodiments, the livestream event can be hosted by a social network. As the livestream event occurs, a QR code is displayed on the CTV device. The QR code can be scanned by a camera on a mobile device. The QR code includes a Uniform Resource Locator (URL) which directs a mobile device to the livestream site in progress. The livestream event can be displayed on the mobile device using an internet browser or other application running on the mobile device. The livestream event can include a chat feature allowing interaction between the livestream host and viewers of the livestream event. The chat feature can be displayed on the mobile device viewing the livestream event, allowing the viewer to participate in the livestream chat. The chat interactions are displayed on the mobile device and the CTV device.

The infographic 300 includes a CTV device 310 displaying a livestream event 320. In embodiments, the livestream event can be viewed in real time or replayed at a later time. In some embodiments, the livestream event can be hosted by a social network. The CTV device can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The device for CTV can be a connected public or commercial display. As the livestream event occurs, a livestream host 340 can be viewed as a video feed in real time. A chat box 350 can be displayed in the livestream window so that viewers can interact with one another and the livestream host as the event progresses.

The infographic 300 includes a QR code 330 that can be displayed on the CTV screen 310 as the livestream event occurs. A QR code is a machine-readable matrix barcode made up of an array of black and white squares. QR codes are typically used to store URLs or other information to be read by a camera on a smartphone. A single QR code can contain up to three hundred alphanumeric characters. QR codes can be easily generated using standardized software available for little or no cost. In embodiments, a QR code containing the web address of a livestream URL can be generated and revealed on the screen of a CTV device 310 as the livestream progresses. The infographic 300 includes a user scanning a QR code 330 using a camera 370 in a mobile device 360. An optical scanning program included on a mobile phone can read the QR code displayed on a CTV screen 310 and translate the code into a URL address that allows the user to participate in the livestream event on the mobile phone 360. In embodiments, the accessing the livestream on the mobile device can be accomplished using a browser or another application running on the mobile device.

The infographic 300 includes a mobile device 360 that can scan a QR code using a camera 370 included on the mobile device. An optical scanning program included on a mobile phone can read the QR code 330 displayed on a CTV screen 310 and translate the code into a URL address that allows the user to participate in the livestream event 320 on the mobile phone 360. In embodiments, the accessing the livestream event on the mobile device can be accomplished using a browser or another application running on the mobile device. The livestream window 380 on the mobile device 360 can include the livestream host video feed 382 and chat window 390 that are displayed on the CTV device. The chat window 390 can include a message window 392 that allows the mobile device user to type in messages as part of the livestream chat. The messages sent by the mobile device user can be displayed in the chat window 390 on the mobile device 360 and in the chat window 350 on the CTV device 310. Thus, a viewer can view the livestream event 320 including the host video feed 340 and chat window 350 on a CTV device 310 and participate in the livestream event 370 using a mobile device 360 that allows viewing the host video feed 382 and chat window 390 and chat message window 392 simultaneously.

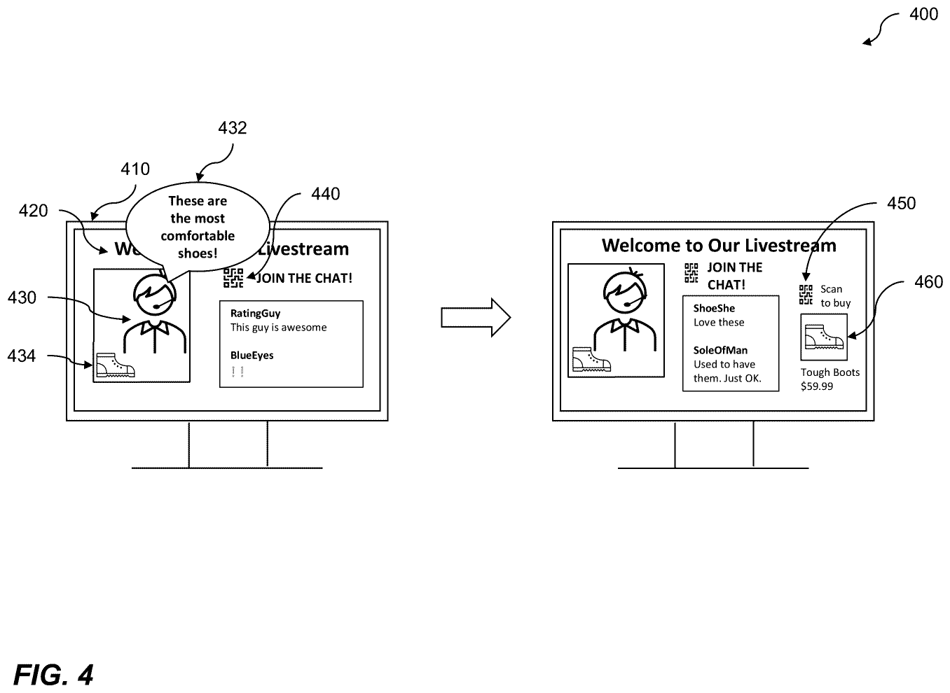

FIG. 4 is an infographic for pinning a product card based on speech analysis. A livestream event is displayed on a CTV device. The CTV device can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The device for CTV can be a connected public or commercial display. In some embodiments, the livestream event can be hosted by a social network. The livestream event can include QR code displayed on the CTV device. The QR code can be scanned by a camera on a mobile device. The QR code includes a Uniform Resource Locator (URL) which directs a mobile device to the livestream site in progress. The livestream event can include a chat feature allowing interaction between the livestream host and viewers of the livestream event. During the livestream event, the host can highlight at least one product for sale in the livestream event. In embodiments, at least one product for sale can be a service or event. Depending on the type of product, the livestream host can handle the product, demonstrate the product, etc. The livestream event can include pinning a product card in the livestream window by the host. The product card that is pinned represents the at least one product for sale. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or another suitable user action. When the product card is invoked, an additional on-screen display is rendered over a portion of the video while the video continues to play.

The infographic 400 includes alerting the livestream host to pin a product card associated with the at least one product for sale. The alerting can occur when the host is identified to be highlighting the at least one product for sale. The identifying that the host is highlighting a product can be accomplished using a variety of techniques. The identifying can also be based on speech analysis. The speech analysis, which can be accomplished using natural language processing, can be used to determine when the host is talking about the product. The host may or may not be handling the product while they are talking about the product. In embodiments, the identification of products is performed automatically, and a product tag, which can include a highlight indication, is generated and rendered on the video. A second QR code can be generated and rendered on the CTV device. The QR code can be scanned by a viewer using a camera on a mobile device. The second QR code can generate an ecommerce environment window as part of the livestream displayed on the mobile device and allow the user to purchase products and services for sale as part of the livestream event.

The infographic 400 includes a CTV device 410 displaying a livestream event 420. In embodiments, the livestream event 420 can be viewed in real time or replayed at a later time. In some embodiments, the livestream event 420 can be hosted by a social network. The CTV device 410 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The device 410 for CTV can be a connected public or commercial display. As the livestream event occurs, a livestream host 430 can be viewed as a video feed in real time. A QR code 440 directing a mobile device user to the livestream can be displayed along with a chat box in the livestream window so that viewers can interact with one another and the livestream host as the event progresses.

The infographic 400 includes the livestream host 430 highlighting a product for sale in the livestream event. In embodiments, depending on the type of product, the livestream host 430 can handle the product, demonstrate the product, etc. As the livestream host 430 highlights the product for sale, the host can be alerted to pin a product card 460 associated with the at least one product for sale. The alerting can occur when the host 430 is identified to be highlighting the at least one product for sale 434. The identifying that the host 430 is highlighting a product can be accomplished using a variety of techniques. The identifying can also be based on speech analysis 432. The speech analysis 432, which can be accomplished using natural language processing, can be used to determine when the host 430 is talking about the product. The host may or may not be handling the product while they are talking about the product. In embodiments, the identification of products is performed automatically, and a product tag, which can include a highlight indication, is generated and rendered on the video.

The infographic 400 includes a second QR code 450 generated and rendered on the CTV device 410. In embodiments, the second QR code 450 can be scanned by a camera on a mobile device by a viewer. The second QR code 450 can direct the mobile device user to an ecommerce environment window as part of the livestream event on the mobile device. The CTV device can also display the product for sale along with the second QR code 450. In some embodiments, promotions and coupons can be displayed as part of the product card. The ecommerce purchase can be accomplished within the livestream window. Viewers of the livestream event can purchase a product, a service, etc. being promoted by the host of the livestream event. A viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event.

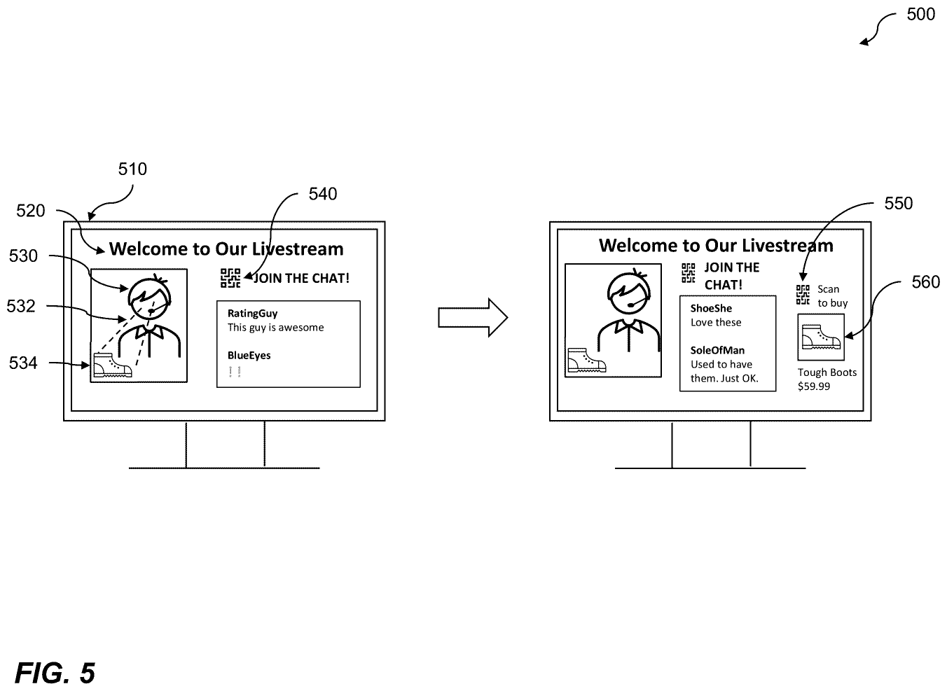

FIG. 5 is an infographic for pinning a product card based on gaze detection. A livestream event is displayed on a CTV device. The CTV device can be a smart TV which can be directly attached to the Internet; a television connected to the internet via a cable box, TV stick, or game console; an Over-the-Top (OTT) device such as a mobile phone, laptop computer, tablet, pad, or desktop computer; etc. The device for CTV can be a connected public or commercial display. In some embodiments, the livestream event can be hosted by a social network. The livestream event can include QR code displayed on the CTV device. The QR code can be scanned by a camera on a mobile device. The QR code includes a Uniform Resource Locator (URL) which directs a mobile device to the livestream site in progress. The livestream event can include a chat feature allowing interaction between the livestream host and viewers of the livestream event. During the livestream event, the host can highlight at least one product for sale in the livestream event. In embodiments, at least one product for sale can be a service or event. Depending on the type of product, the livestream host can handle the product, demonstrate the product, etc. The livestream event can include pinning a product card in the livestream window by the host. The product card that is pinned represents the at least one product for sale. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. When the product card is invoked, an additional on-screen display is rendered over a portion of the video while the video continues to play.

The infographic 500 includes alerting the livestream host to pin a product card associated with the at least one product for sale. The alerting can occur when the host is identified to be highlighting the at least one product for sale. The identifying that the host is highlighting a product can be accomplished using a variety of techniques. The identifying can be based on gaze detection. Gaze detection can be used to determine whether one or more of the hosts are gazing in the direction of the product for sale. A coordinate system can be used to describe the gaze detection problem. In embodiments, the identification of products is performed automatically, and a product tag, which can include a highlight indication, is generated and rendered on the video. A second QR code can be generated and rendered on the CTV device. The QR code can be scanned by a viewer using a camera on a mobile device. The second QR code can generate an ecommerce environment window as part of the livestream displayed on the mobile device and can allow the user to purchase products and services for sale as part of the livestream event.

The infographic 500 includes a CTV device 510 displaying a livestream event 520. In embodiments, the livestream event 520 can be viewed in real time or replayed at a later time. In some embodiments, the livestream event 520 can be hosted by a social network. The CTV device 510 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The device 510 for CTV can be a connected public or commercial display. As the livestream event occurs, a livestream host 530 can be viewed as a video feed in real time. A QR code 540 directing a mobile device user to the livestream can be displayed along with a chat box in the livestream window so that viewers can interact with one another and the livestream host as the event progresses.

The infographic 500 includes the livestream host 530 highlighting a product for sale 534 in the livestream event. In embodiments, depending on the type of product, the livestream host 530 can handle the product, demonstrate the product, etc. As the livestream host 530 highlights the product for sale, the host can be alerted to pin a product card 560 associated with the at least one product for sale. The alerting can occur when the host 530 is identified to be highlighting the at least one product for sale. The identifying that the host 530 is highlighting a product can be accomplished using a variety of techniques. The identifying can be based on gaze detection 532. Gaze detection 532 can be used to determine whether the host is gazing in the direction of the product for sale 534. A coordinate system can be used to describe the gaze detection problem. In embodiments, the gaze detection 532 is accomplished using a cylindrical coordinate system. The cylindrical coordinate system can include a distance or radius, an angle, and a height. The gaze detection 532 can determine whether a host is gazing at the product 534. In embodiments, the gaze detection 532 includes an angle of the host's face relative to the product for sale. In embodiments, the identification of products is performed automatically, and a product tag, which can include a highlight indication, is generated and rendered on the video.

The infographic 500 includes a second QR code 550 generated and rendered on the CTV device 510. In embodiments, the second QR code 550 can be scanned by a camera on a mobile device by a viewer. The second QR code 550 can direct the mobile device user to an ecommerce environment window as part of the livestream event on the mobile device. The CTV device can also display the product for sale along with the second QR code 550. In some embodiments, promotions and coupons can be displayed as part of the product card. The ecommerce purchase can be accomplished within the livestream window. Viewers of the livestream event can purchase a product, a service, etc. being promoted by the host of the livestream event. A viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event.

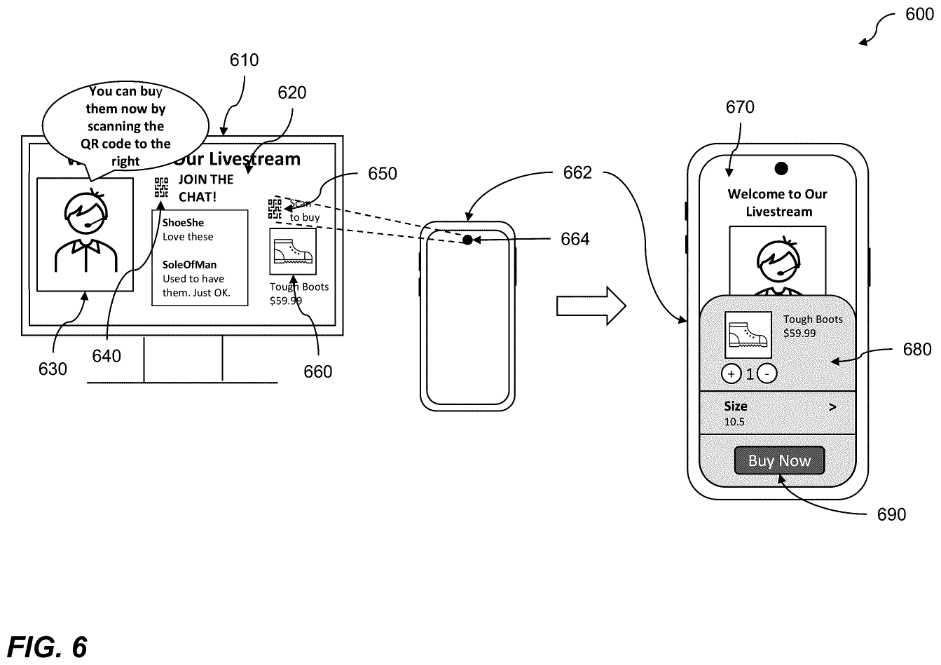

FIG. 6 is an infographic for an ecommerce purchase environment on a mobile device. A livestream event is displayed on a CTV device. The CTV device can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The device for CTV can be a connected public or commercial display. In some embodiments, the livestream event can be hosted by a social network. As the livestream event occurs, a QR code is displayed on the CTV device. The QR code can be scanned by a camera on a mobile device. The QR code includes a Uniform Resource Locator (URL) which directs a mobile device to the livestream site in progress. The livestream event can be displayed on the mobile device using an internet browser or other application running on the mobile device. The livestream event can include a chat feature allowing interaction between the livestream host and viewers of the livestream event. The chat feature can be displayed on the mobile device viewing the livestream event, allowing the viewer to participate in the livestream chat. The chat interactions can be displayed on the mobile device and the CTV device. During the livestream event, the host can highlight at least one product for sale in the livestream event. In embodiments, at least one product for sale can be a service or event. Depending on the type of product, the livestream host can handle the product, demonstrate the product, etc. The livestream event can include pinning a product card in the livestream window by the host. The product card that is pinned represents the at least one product for sale. Embodiments can include inserting a representation of the first object into the on-screen product card. When the product card is invoked, an additional on-screen display is rendered over a portion of the video while the video continues to play. A second QR code can be generated and rendered on the CTV device. The QR code can be scanned by a viewer using a camera on a mobile device. The second QR code can generate an ecommerce environment window as part of the livestream displayed on the mobile device, and can allow the user to purchase products and services for sale as part of the livestream event.

The infographic 600 includes a CTV device 610 displaying a livestream event 620. In embodiments, the livestream event can be viewed in real time or replayed at a later time. In some embodiments, the livestream event can be hosted by a social network. The CTV device can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The device for CTV can be a connected public or commercial display. As the livestream event occurs, a livestream host 630 can be viewed as a video feed in real time. In some embodiments, a chat box can be displayed in the livestream window so that viewers can interact with one another and the livestream host as the event progresses.

The infographic 600 includes a QR code 640 that can be displayed on the CTV screen 610 as the livestream event occurs. A QR code is a machine-readable matrix barcode made up of an array of black and white squares. QR codes are typically used to store URLs or other information to be read by a camera on a smartphone. A single QR code can contain up to three hundred alphanumeric characters. The QR codes can be easily generated using standardized software available for little or no cost. In embodiments, a QR code 640 containing the web address of a livestream URL can be generated and revealed on the screen of a CTV device 610 as the livestream progresses. An optical scanning program included on a mobile phone can read the QR code 640 displayed on a CTV screen 610 and translate the code into a URL address that allows the user to participate in the livestream event on the mobile phone. In embodiments, the accessing the livestream on the mobile device can be accomplished using a browser or another application running on the mobile device.

The infographic 600 includes generating and revealing a second QR code 650 in the livestream event product card 660 on the CTV device. In embodiments, the second QR code 650 contains information to render an ecommerce environment related to the livestream event on the mobile device 662. The ecommerce environment 680 is rendered on the mobile device 662 after scanning the QR code 650 using a camera 664 included on the mobile device. The viewer of a livestream event can scan the second QR code 650 using the same mobile device 662 that was used with the first QR code. In embodiments, the ecommerce environment is rendered on the mobile device so that livestream event is still visible. The product card in the ecommerce environment 680 is selectable via a user interface action such as a press, swipe, gesture, mouse click, verbal utterance, or other suitable action. In other words, the user is not redirected to another site or portal that causes the video playback to stop. Thus, users are able to initiate and complete a purchase completely inside of the video playback user interface, without being redirected away from the currently playing video. Allowing the video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. In the infographic 600, the pinning can be accomplished using one or more processors. The processors can be associated with a computing device such as a desktop or laptop computer. The processors can be associated with a server on which the livestream event is hosted.

The infographic 600 includes rendering an ecommerce environment 680 enabling a purchase of the at least one product for sale by the viewer, wherein the ecommerce purchase is accomplished within the livestream window 670. The revealing can include a virtual purchase cart comprising an ecommerce environment 680 that supports checkout 690, including specifying various payment methods, and applying coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items are purchased via product cards during the playback of a short-form video, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

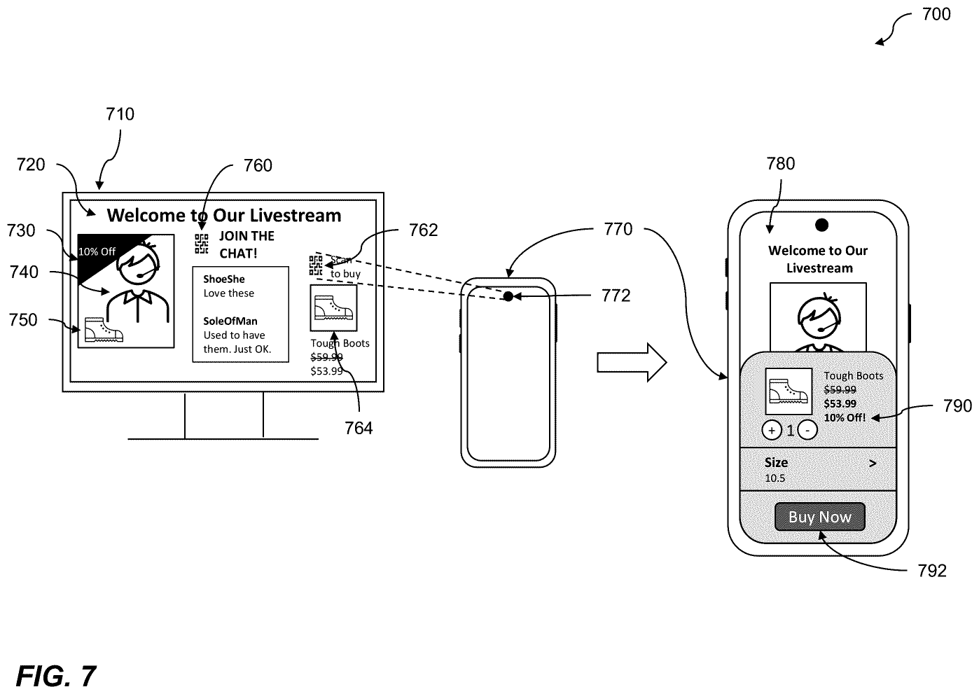

FIG. 7 is an infographic for a promotion in the livestream. Discussed previously and throughout, a product card can be pinned in the livestream window by the livestream host. The product card that is pinned can represent the at least one product for sale. A viewer can use a CTV device to view a livestream event. CTV devices can include a computer device, a portable device, a handheld device, and so on. The viewer can view the livestream event within a video player window. The video player window can include a window opened by a video player associated with a web browser, a video streaming app, and the like. An ecommerce site can be rendered within the player window. The rendering of the ecommerce site can include an ecommerce site name, menu options, a search function, and so on. The product that is being offered can also be rendered within the video player window. The product can be rendered as a photo, a highlighted image of the product, a representation of the item, and so on. The livestream event can continue to play within the video player window while the viewer interacts with the ecommerce site. A rendering of the livestream event can include a host video feed, a chat window, viewer names, viewer questions and comments, etc. The viewer names and associated text can be obtained from feeds such as social media feeds associated with the livestream event. The social media feeds can be monitored during the livestream event. The unfiltered social media questions and comments can be added to the livestream event rendering, selected by one or more hosts, and so on. The livestream can further include an icon or other representation of a virtual purchase cart. Clicking on the representation of the virtual purchase cart can open the cart to see cart contents, can add a product to the cart, etc. At various points within the livestream event, a coupon can be rendered within the video player window. The coupon can offer discounts, free product shipment, free additional products if the product is purchased, and so on. The coupon can be presented at various points within the livestream event. The coupon can include a time-limited coupon such as “Buy within the next 5 minutes and save 10%.” The coupon can include a time sensitive coupon. In a usage example, a coupon can begin by offering a discount such as a 10% discount. As time passes, the amount of the discount offered by the coupon can decrease.

The infographic 700 includes a CTV device 710 displaying a livestream event 720. In embodiments, the livestream event can be viewed in real time or replayed at a later time. In some embodiments, the livestream event can be hosted by a social network. The CTV device can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The device for CTV can be a connected public or commercial display. As the livestream event occurs, a livestream host 740 can be viewed as a video feed in real time. The host 740 can be highlighting at least one product for sale 750. In some embodiments, a chat box can be displayed in the livestream window so that viewers can interact with one another and the livestream host as the event progresses.

The infographic 700 includes a QR code 760 that can be displayed on the CTV screen 710 as the livestream event occurs. A QR code is a machine-readable matrix barcode made up of an array of black and white squares. QR codes are typically used to store URLs or other information to be read by a camera on a smartphone. A single QR code can contain up to three hundred alphanumeric characters. QR codes can be easily generated using standardized software available for little or no cost. In embodiments, a QR code 760 containing the web address of a livestream URL can be generated and revealed on the screen of a CTV device 710 as the livestream progresses. An optical scanning program included on a mobile phone can read the QR code 760 displayed on a CTV screen 710 and can translate the code into a URL address that allows the user to participate in the livestream event 780 on the mobile phone 770. In embodiments, the accessing the livestream 780 on the mobile device 770 can be accomplished using a browser or another application running on the mobile device.

The infographic 700 includes generating and revealing a second QR code 762 in the livestream event product card 764 on the CTV device 710. In embodiments, the second QR code 762 contains information to render an ecommerce environment 790 related to the livestream event on the mobile device 770. The ecommerce environment 790 is rendered on the mobile device 770 after scanning the QR code 762 using a camera 772 included on the mobile device. The viewer of a livestream event can scan the second QR code 762 using the same mobile device 770 that was used with the first QR code. In embodiments, the ecommerce environment 790 is rendered on the mobile device 770 so that livestream event 780 is still visible. The product card in the ecommerce environment 790 is selectable via a user interface action such as a press, swipe, gesture, mouse click, verbal utterance, or other suitable action. In other words, the user is not redirected to another site or portal that causes the video playback to stop. Thus, users are able to initiate and complete a purchase 792 completely inside of the video playback user interface, without being directed away from the currently playing video. Allowing the video to play during the purchase can enable improved audience engagement which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. In the infographic 700, the pinning is accomplished using one or more processors. The processors can be associated with a computing device such as a desktop or laptop computer. The processors can be associated with a server on which the livestream event is hosted.

The infographic 700 includes a coupon 730 that can be rendered within the video player window on the CTV device 710. The coupon can offer discounts, free product shipment, free additional products if the product is purchased, and so on. The coupon can be presented at various points within the livestream event. The coupon can include a time limited coupon such as “Buy within the next 5 minutes and save 10%.” The coupon can include a time sensitive coupon. In a usage example, a coupon can begin by offering a discount such as a 10% discount. As time passes, the amount of the discount offered by the coupon can decrease. The coupon can be rendered on the mobile device 770 within the ecommerce window 790, offering the same discount, such as a 10% discount as shown.

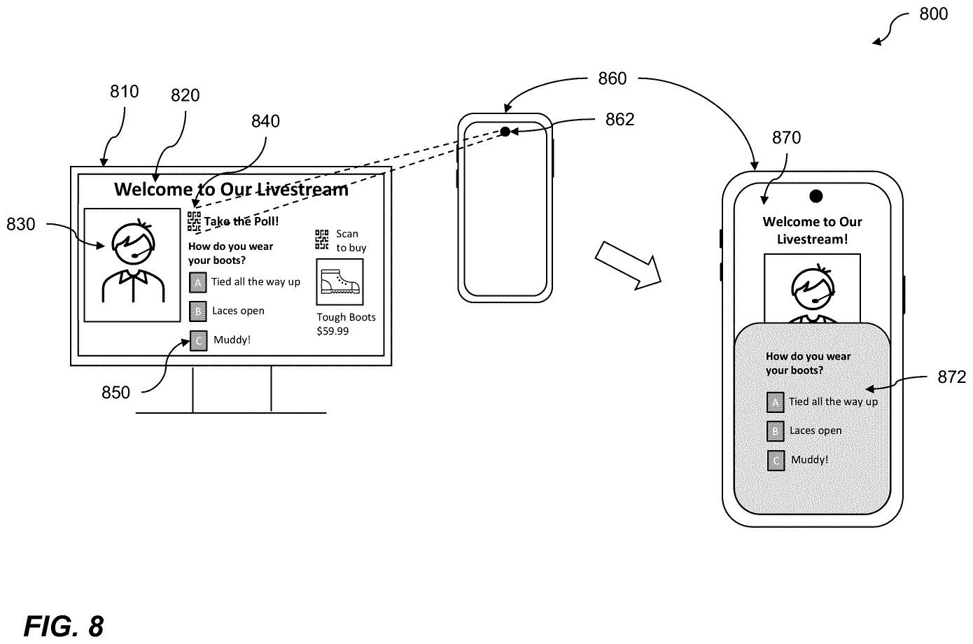

FIG. 8 is an infographic for a poll in a livestream ecommerce environment. During a livestream event, a host of the livestream event can choose to submit a question to the viewers, to poll the viewers for an opinion, and so on. The question or poll can be associated with the product on display within the livestream, a general survey such as gauging the joy of a viewer who is shopping online with other viewers, and so on. The poll or the question can be presented to a viewer, a subset of the plurality of viewers, all of the viewers, and so on. Depending on an answer provided by one or more viewers, further questions and polls may be initiated. The including questions and polls in a livestream enables a multi-hosted livestream in an open web ecommerce environment. A viewer can use an electronic device to view a livestream event in which questions and polls can be included. An electronic device can include any of a variety of personal electrotonic devices such as a CTV device, a computer device, a portable device, a handheld device, and so on. The viewer can view the livestream event within a video player window. The video player window can include a web browser window, a video streaming app, etc.

The infographic 800 includes a CTV device 810 displaying a livestream event 820. In embodiments, the livestream event can be viewed in real time or replayed at a later time. In some embodiments, the livestream event can be hosted by a social network. The CTV device can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The device for CTV can be a connected public or commercial display. As the livestream event occurs, a livestream host 830 can be viewed as a video feed in real time. In some embodiments, a product card can be displayed in the livestream window so that viewers can purchase products and services as the event progresses.

The infographic 800 includes a livestream host 830. The livestream host can submit a poll or question to the viewers of the livestream event. A host creates and submits a poll 850 which can appear in the livestream event window on a CTV device. A sample poll 872, which posits a simple question and seeks an “A”, “B”, or “C” response, is shown. When the viewer has made her or his decision about their answer to the poll, they can click the “A”, “B”, or “C” button. Simple yes/no poll questions can also be submitted by the host to an individual viewer, a subset of the plurality of viewers, all of the viewers, etc. The poll or question can have a time limit within which a viewer can respond. If the viewer does not respond in time, then the poll or question can be removed from the livestream. In a usage example, a time-limited question can include, “Do you want free shipping?” A poll or question can include a follow-up poll or question. In a usage example, a viewer can be asked whether she or he would like to receive further information, special offers, information from relevant third-party vendors, and so on. If the viewer responds positively, then a follow-up question can include a preference for text or email communication, a cell phone number, an email address, etc.

The infographic 800 includes a QR code 840 that can be displayed on the CTV screen 810 as the livestream event 820 occurs. A QR code is a machine-readable matrix barcode made up of an array of black and white squares. QR codes are typically used to store URLs or other information to be read by a camera on a smartphone. A single QR code can contain up to three hundred alphanumeric characters. QR codes can be easily generated using standardized software available for little or no cost. In embodiments, a QR code 840 containing the web address of a livestream URL can be generated and revealed on the screen of a CTV device 810 as the livestream progresses. An optical scanning program included on a mobile phone 860 can scan the QR code 840 using a camera 862 included on the mobile phone and can translate the code into a URL address that allows the user to participate in the livestream event 870 on the mobile phone 860. In embodiments, the accessing the livestream 870 on the mobile device 860 can be accomplished using a browser or another application running on the mobile device.

In embodiments, the poll or question 872 is rendered on the mobile device 860 so that livestream event 870 is still visible. In other words, the user is not redirected to another site or portal that causes the video playback to stop. Thus, users are able to respond to a poll question 872 completely inside of the video playback user interface, without being directed away from the currently playing video. Allowing the video to play during the poll can enable improved audience engagement which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. In the infographic 800, the polling is accomplished using one or more processors. The processors can be associated with a computing device such as a desktop or laptop computer. The processors can be associated with a server on which the livestream event is hosted.

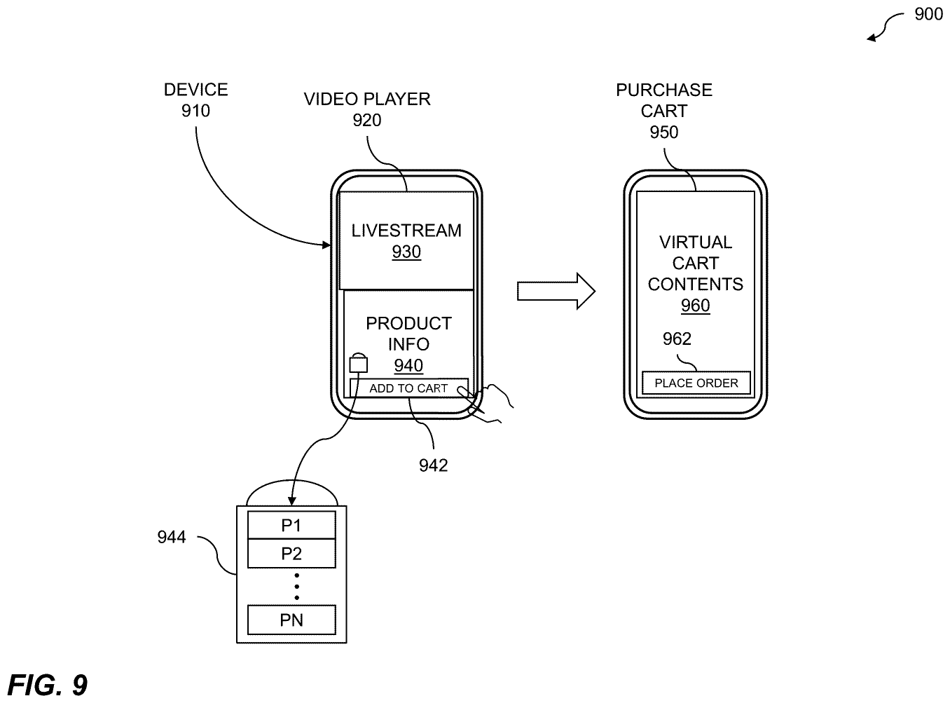

FIG. 9 is an infographic for a virtual purchase cart in a livestream ecommerce environment. A viewer can observe a livestream event in which a product is introduced, promoted, endorsed, recommended, and so on. The viewer can choose to learn more about the product, and if interested, can add the product to a virtual purchase bag or cart in order to purchase the product. The user can examine the product, learn details about the product, purchase the product, etc., without leaving the livestream that contains the product. Instead, the livestream can continue to play while the user is learning more about the product, purchasing the product via an ecommerce checkout technique, etc. The add-to-cart operation and the ecommerce checkout can be accomplished by clicking on an icon representing a virtual purchase cart or by interacting with the product within the livestream. The interaction can include tapping, clicking, swiping, mousing over or hovering, and the like.

The infographic 900 includes a device 910 that can be used to display a livestream event 930 within a video player 920 included on the device. The device 910 can include any of a variety of electronic devices such as a hand-held electronic device, a portable electronic device, a desktop electronic device, and so on. In addition to the livestream host video 930, a product card 940 can be rendered within the video player 920. The product can include a cosmetic or hair care product; clothing; jewelry; household items such as furniture, window treatments, or bedding; tools; a service; a cruise; a vacation package; and the like. The product card 940 that is rendered can be determined by one or more products that were highlighted based on actions of a host individual within the livestream video 930, or based on other criteria. The host actions can include handing the product, talking about the product, gazing at the product, etc. In embodiments, the host interactions can be identified based on machine learning (ML) techniques. The product card 940 can be rendered based on viewer actions. The viewer actions can include clicking on, tapping, mousing over, etc. the product with the livestream. The viewer actions can further be determined based on metadata. In embodiments, the metadata can include hashtags, repost velocity, participant attributes, participant history, ranking, product purchase history, view history, or participant actions.

A variety of information types and content can be provided to the viewers of the livestream event 930 using a video player 920. The video player 920 can be associated with a web browser, a web access application, a video streaming app, etc. loaded on an electronic device associated with a viewer. The app can include a livestream viewing app. Purchase details of the at least one product for sale can be revealed, based on a first action with the product card by a viewer. The revealing is rendered for the viewer in the viewer's device. When a viewer interacts (e.g., by tapping, clicking, mousing over, etc.) with the product card 940, the product details and information can be revealed to the viewer. The product information 940 can be overlaid on the livestream event 930 which continues to play in the video player on the device. In embodiments, an “Add to Cart” button 942 can be selected, where the product is placed into a virtual purchase cart. The expanded purchase cart 950 can include a checkout control such as a “Place Order” button 962. The product information can further include a virtual purchase cart icon 960. More than one product can be present in the virtual purchase cart. The one or more products can be added throughout the livestream event, as products are shown or highlighted, as the viewer decides to add the products, etc. The virtual purchase cart can include one or more products 944 such as product P1, product P2, product PN and so on. Invoking the purchase control 962 can cause the electronic device 910 to enable an ecommerce purchase of the items corresponding to entries (P1-PN) in the virtual purchase cart.

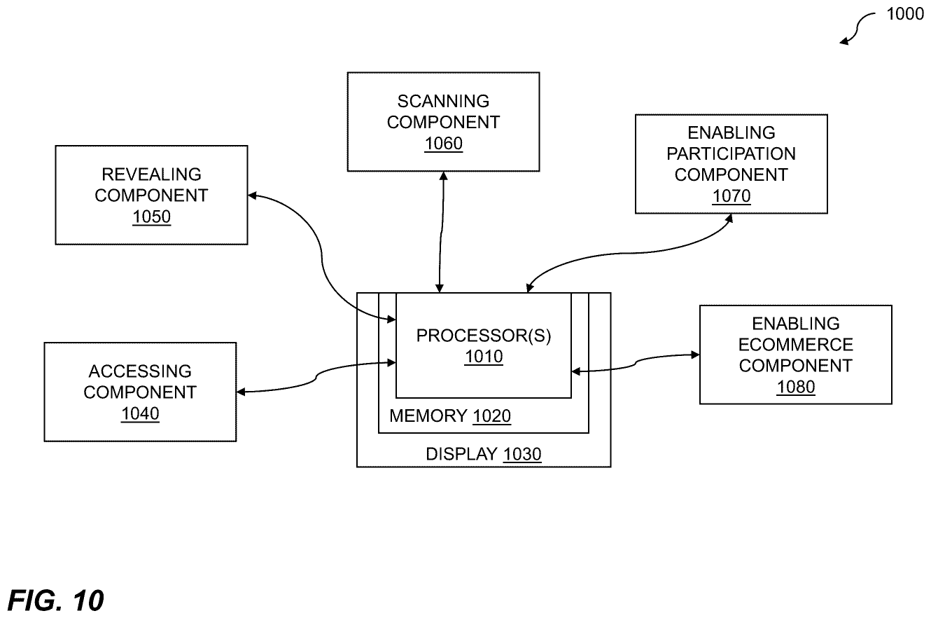

FIG. 10 is a system diagram for connected television livestream-to-mobile device handoff in an ecommerce environment. The system 1000 can include one or more processors 1010 coupled to a memory 1020 which stores instructions. The system 1000 can include a display 1030 coupled to the one or more processors 1010 for displaying data, video streams, videos, highlighted products, product information, product cards, virtual purchase cart contents, chats, polls, webpages, intermediate steps, instructions, and so on. In embodiments, one or more processors 1010 are coupled to the memory 1020 where the one or more processors, when executing the instructions which are stored, are configured to: access a livestream on a device for connected television CTV, wherein the CTV facilitates delivery of streaming video content to a user; reveal a quick response (QR) code on the device for CTV; scan the QR code, by the user, with a camera located on a mobile device, wherein the QR code redirects the mobile device to a website; enable participation in the livestream by the user, via the website, wherein the enabling is accomplished with the mobile device; and enable an ecommerce purchase of a product for sale using the mobile device.

The system 1000 includes an accessing component 1040. The accessing component 1040 can include functions and instructions for accessing a livestream on a device for connected television (CTV), wherein the CTV facilitates delivery of streaming video content to a user. Connected television (CTV) is any television set connected to the Internet. CTVs are most commonly used to stream videos. As well as smart TVs with built-in internet connectivity, CTVs can include televisions connected to the Internet via set-top boxes, TV sticks, and gaming consoles. Connected TV can also include Over-the-Top (OTT) video devices or services accessed by a laptop, desktop, pad, or mobile phone. Content for television can be accessed directly from the Internet without using a cable or satellite set-top box. For example, watching a movie or television episode using a laptop or mobile phone browser is considered OTT. In some embodiments, CTV can include a connected public or commercial display. Wi-Fi hotspots built into public parks, transportation portals, government buildings, and so on can allow visitors and employees to connect to both public and secure content via mobile phones, pads, or laptop computers. Visitor centers can allow users to purchase tickets to events in advance and receive guided tours of zoos and other attractions via mobile phones, etc. Any of these devices or services can be used to access livestream events as they occur or as they are replayed by a host system at a later time. The livestream event can appear on a social network in real time or as a replay.

The system 1000 includes a revealing component 1050. The revealing component 1050 can include functions and instructions for revealing a quick response (QR) code on the device for CTV. A QR code is a machine-readable matrix barcode made up of an array of black and white squares. QR codes are typically used to store URLs or other information to be read by a camera on a smartphone. A single QR code can contain up to three hundred alphanumeric characters. QR codes can be easily generated using standardized software available for little or no cost. In embodiments, a QR code containing the web address of a livestream URL can be generated and revealed on the screen of a CTV device as the livestream progresses. The revealing component 1050 can be used to reveal a second QR code within a shopping window on the CTV device. The second QR code can be used to direct a mobile device to an ecommerce environment associated with the livestream event. The viewer can choose to learn more about the product, and if interested, can add the product to a virtual purchase bag or cart in order to purchase the product. The user can examine the product, learn details about the product, purchase the product, etc. without leaving the livestream that contains the product. Instead, the livestream can continue to play while the user is learning more about the product, purchasing the product via an ecommerce checkout technique, etc. The add-to-cart operation and the ecommerce checkout can be accomplished by clicking on an icon representing a virtual purchase cart or by interacting with the product within the livestream. The interaction can include tapping, clicking, swiping, mousing over or hovering, and the like.

The revealing component 1050 can be used to reveal another QR code within a chat window on the CTV device. The QR code can be used to direct a mobile device to a chat window associated with the livestream event. The chat window can include a message window that allows the mobile device user to type in messages as part of the livestream chat. The messages sent by the mobile device user can be displayed in the chat window on the mobile device and in the chat window on the CTV device. Thus, a viewer can view the livestream event including the host video feed and chat window on a CTV device and can participate in the livestream event using a mobile device that allows viewing the host video feed, chat window, and chat message window simultaneously.

The system 1000 includes a scanning component 1060. The scanning component 1060 can include functions and instructions for scanning the QR code, by the user, with a camera located on a mobile device, wherein the QR code redirects the mobile device to a website. A QR code is a machine-readable matrix barcode made up of an array of black and white squares. QR codes are typically used to store URLs or other information to be read by a camera on a smartphone. A single QR code can contain up to three hundred alphanumeric characters. QR codes can be easily generated using standardized software available for little or no cost. In embodiments, a QR code containing the web address of a livestream URL can be generated and revealed by the revealing component 1050 on the screen of a CTV device as the livestream progresses. When the QR code is scanned by a camera on a mobile device, an optical scanning program included on the mobile device can read the QR code and translate the code into a URL address that allows the user to participate in the livestream event on the mobile phone. In embodiments, the accessing the livestream on the mobile device can be accomplished using a browser or another application running on the mobile device. The scanning component 1060 can be used to scan a second QR code that can be used to direct a mobile device to an ecommerce environment associated with the livestream event. As discussed earlier, the ecommerce environment can allow users to access more details on products and services offered for sale as part of the livestream event. A viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. The scanning component 1060 can be used to scan an additional QR code that can be used to direct a mobile device to a chat window associated with the livestream event. As discussed earlier, the chat window can allow users to interact with other viewers of the livestream event and the host of the event. The user can respond to questions or polls generated during the livestream event. As with the ecommerce environment, the mobile device user can participate in chats without having to “leave” the livestream event.

The system 1000 includes an enabling participation component 1070. The enabling participation component 1070 can include functions and instructions for enabling a chat window, including polls and questions, etc. associated with a livestream event on a mobile device, wherein the chat is accomplished within the livestream window. One or more of the plurality of viewers of the livestream event can participate in a chat as part of the livestream event. A viewer can chat without having to “leave” the livestream event. Leaving the livestream event can include having to disconnect from the event, open a chat window separate from the livestream event, and so on. The livestream event can continue while the viewer is engaged with the chat. In embodiments, the livestream event can continue “behind” the chat window, where the virtual purchase window can obscure or partially obscure the livestream event. The livestream host can submit a poll or question to the viewers of the livestream event which can appear in the livestream event window on a CTV device. The contents of the chat window can appear in the chat window on the mobile device at the same time. When the viewer has made her or his decision about their answer to the poll, they can click the “A”, “B”, or “C” button. Simple yes/no poll questions can also be submitted by the host to an individual viewer, a subset of the plurality of viewers, all of the viewers, etc. The poll or question can have a time limit within which a viewer can respond. If the viewer does not respond in time, then the poll or question can be removed from the livestream. In a usage example, a time-limited question can include, “Do you want free shipping?” A poll or question can include a follow-up poll or question. In a usage example, a viewer can be asked whether she or he would like to receive further information, special offers, information from relevant third-party vendors, and so on. If the viewer responds positively, then a follow-up question can include a preference for text or email communication, a cell phone number, an email address, etc.

The system 1000 can include an enabling ecommerce component 1080. The enabling ecommerce component 1080 can include functions and instructions for enabling an ecommerce purchase of the at least one product for sale by the viewer, wherein the ecommerce purchase is accomplished within the livestream window. One or more of the plurality of viewers of the livestream event can purchase a product, a service, etc. being promoted by the host of the livestream event. A viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. In embodiments, the enabling can include a virtual purchase cart, wherein the virtual purchase cart is rendered to the viewer. The virtual purchase cart can be presented as a GIF, an icon, a pictogram, an emoji, and so on. The virtual purchase cart can be represented by a cart, a basket, a bag, a tote, and so on. In embodiments, the livestream event can display the virtual purchase cart to the viewer during the livestream based on a second action by the viewer. The second action can include making a product selection, choosing a product color or size, selecting a product quantity, etc. In embodiments, the virtual purchase cart rendered to the viewer covers a portion of the livestream window. The virtual purchase cart can be expanded so that the viewer can observe the contents of the cart, can be reduced in size, or minimized, and so on.

The enabling ecommerce component 1080 can include coupons, virtual purchase carts, and/or other information related to a highlighted product in the livestream event. The coupons can include QR codes, barcodes, alphanumeric codes, and the like. The virtual purchase carts can enable ecommerce purchase of one or more products that are shown and/or mentioned in the livestream event. The purchase details can include a link to an ecommerce site, an “Add to Cart” button, a representation of a digital shopping bag or shopping cart, and so on. The purchase details can include size or color selections, a desired quantity, etc. A first action can include clicking on the product card, tapping the card, moving a cursor on the card, and so on. In embodiments, the viewer to whom the purchase details are revealed can be from a plurality of viewers. The enabling ecommerce component can deliver purchase details to more than one viewer. In addition to showing purchase details, other offers, incentives, and so on can be presented to the viewer. Further embodiments can include presenting a first coupon overlay to the viewer, wherein the presenting is rendered to the viewer. The coupon can include a discount, a time-based discount such as, “Buy within the next 5 minutes”, a countdown coupon where the amount of a discount decreases over time, a “buy one get one” (i.e., BOGO) coupon, etc. In other embodiments, the presenting can include a second coupon overlay rendered to a second viewer, wherein the first coupon overlay and the second coupon overlay are different. Differences between the first coupon overlay and the second coupon overlay can include different discount amounts, time frames for discounts, incentives, and the like. The coupon overlay differences can be based on a level of viewer interaction, past purchase history, membership level, etc.

Further differences between coupon overlays offered to various viewers of the livestream event can be included. In embodiments, the presenting of a coupon overlay can be based on when the host highlights the at least one product for sale. The coupon overlay can be based on a time point with the livestream event, a product reveal executed by the host, etc. The coupon overlay can be based on a number of products available, number remaining, closeouts, holiday specials, “Black Friday” offerings, “Cyber Monday” events, and so on. In other embodiments, the presenting can be based on the viewer watching the livestream for a period of time. The viewer can be “rewarded” for watching for a period of time, enticed to “convert” (purchase) the item, and the like. In embodiments, the presenting can be based on the pinning of the product card. That is, the coupon, special offer, incentive, etc., is unknown to the one or more viewers until the product card is pinned. Other criteria for presenting a coupon overlay can be based on the familiarity, popularity, and so on of a host. In embodiments, the presenting can be based on the host being a celebrity. The host can further include a media star, a social media influencer, etc. In other embodiments, the presenting can be based on analyzing the viewer's interaction with the livestream. In a usage example, a viewer can like a product, share it with friends, share the product on the viewer's social media feeds, and so on. The viewer can further interact by posting questions about the product on the livestream event, posting comments, etc. In embodiments, the analyzing can be based on metadata. The metadata can be based on actions, activities, etc. performed by the viewer during the livestream event. In embodiments, the metadata can include hashtags, repost velocity, participant attributes, participant history, ranking, product purchase history, view history, or participant actions.

The system 1000 can include a computer program product embodied in a non-transitory computer readable medium for video processing, the computer program product comprising code which causes one or more processors to perform operations of: accessing a livestream on a device for connected television (CTV), wherein the CTV facilitates delivery of streaming video content to a user; revealing a quick response (QR) code, using one or more processors, on the device for CTV; scanning the QR code, by the user, with a camera located on a mobile device, wherein the QR code redirects the mobile device to a website; enabling participation in the livestream by the user, via the website, wherein the enabling is accomplished with the mobile device; and enabling an ecommerce purchase of a product for sale using the mobile device.

In further embodiments, a computer system for video processing is provided comprising: a memory which stores instructions; one or more processors coupled to the memory wherein the one or more processors, when executing the instructions which are stored, are configured to: access a livestream on a device for connected television (CTV), wherein the CTV facilitates delivery of streaming video content to a user; reveal a quick response (QR) code on the device for CTV; scan the QR code, by the user, with a camera located on a mobile device, wherein the QR code redirects the mobile device to a website; enable participation in the livestream by the user, via the website, wherein the enabling is accomplished with the mobile device; and enable an ecommerce purchase of a product for sale using the mobile device.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video processing comprising:
accessing a livestream on a device for connected television (CTV), wherein the CTV facilitates delivery of streaming video content to a user;
revealing a quick response (QR) code, using one or more processors, on the device for CTV;
scanning the QR code, by the user, with a camera located on a mobile device, wherein the QR code redirects the mobile device to a website;
enabling participation in the livestream by the user, via the website, wherein the enabling is accomplished with the mobile device; and
enabling an ecommerce purchase of a product for sale using the mobile device.

2. The method of claim 1 further comprising identifying when a livestream host highlights the product for sale in the livestream.

3. The method of claim 2 wherein the enabling an ecommerce purchase further comprises pinning a product card, using one or more processors, by the livestream host, within a shopping window on the device for CTV.

4. The method of claim 3 wherein the product card represents the product for sale.

5. The method of claim 4 further comprising revealing a second QR code within the shopping window.

6. The method of claim 5 further comprising scanning the second QR code, by the user, with the camera located on the mobile device.

7. The method of claim 6 wherein an ecommerce purchase environment is rendered within a livestream window on the mobile device.

8. The method of claim 7 wherein the ecommerce purchase environment includes a virtual purchase cart.

9. The method of claim 8 wherein the virtual purchase cart is displayed while the livestream plays on the mobile device.

10. The method of claim 8 wherein the virtual purchase cart covers a portion of the livestream on the mobile device.

11. The method of claim 1 wherein the enabling participation in the livestream includes a chat function.

12. The method of claim 11 wherein the chat function includes participating, by the user, in polls and questionnaires.

13. The method of claim 11 wherein information within the chat function appears on the mobile device and the device for CTV.

14. The method of claim 1 further comprising showing at least one promotion, in the livestream, which features the product for sale.

15. The method of claim 14 wherein the promotion is displayed on the device for CTV and the mobile device.

16. The method of claim 1 wherein the enabling participation in the livestream is accomplished in an application running on the mobile device.

17. The method of claim 1 wherein the enabling participation in the livestream includes video on the mobile device.

18. The method of claim 17 wherein the video is displayed on the device for CTV.

19. The method of claim 1 wherein the livestream appears on a social network.

20. The method of claim 1 wherein the product for sale is a service or event that was highlighted in the livestream.

21. The method of claim 1 wherein the accessing a livestream is accomplished with an Over-the-Top (OTT) video device.

22. The method of claim 1 wherein the scanning the QR code redirects the user to an application running on the mobile device.

23. The method of claim 1 wherein the device for CTV comprises a connected public display or a connected commercial display.

24. The method of claim 23 wherein the enabling participation in the livestream includes a chat function.

25. A computer program product embodied in a non-transitory computer readable medium for video processing, the computer program product comprising code which causes one or more processors to perform operations of:
accessing a livestream on a device for connected television (CTV), wherein the CTV facilitates delivery of streaming video content to a user;
revealing a quick response (QR) code, using one or more processors, on the device for CTV;
scanning the QR code, by the user, with a camera located on a mobile device, wherein the QR code redirects the mobile device to a website;
enabling participation in the livestream by the user, via the website, wherein the enabling is accomplished with the mobile device; and
enabling an ecommerce purchase of a product for sale using the mobile device.

26. A computer system for video processing comprising:
a memory which stores instructions;
one or more processors coupled to the memory wherein the one or more processors, when executing the instructions which are stored, are configured to:
access a livestream on a device for connected television (CTV), wherein the CTV facilitates delivery of streaming video content to a user;
reveal a quick response (QR) code on the device for CTV;
scan the QR code, by the user, with a camera located on a mobile device, wherein the QR code redirects the mobile device to a website;
enable participation in the livestream by the user, via the website, wherein enabling is accomplished with the mobile device; and
enable an ecommerce purchase of a product for sale using the mobile device.
